(19) United States
(12) Patent Application Publication
(10) Pub. No.: US 2011/0316878 A1
(43) Pub. Date: Dec. 29, 2011

(54) Computer Implemented Process for Interactive Appreciation of Fine Art

(76) Inventor: Rafael Chodos, Topanga, CA (US)

(21) Appl. No.: 12/826,616

(22) Filed: Jun. 29, 2010

(51) Int. Cl. G09G 5/00; G06F 3/041; G06F 17/30

(52) U.S. Cl. 345/629; 345/173; 707/705; 707/E17.001

(57) ABSTRACT

A computer-implemented process for interactive appreciation of fine art in which a user experiencing an image of fine art may virtually interact with the art image using an input device coupled to a computing system. The input device allows the user to provide a plurality of inputs while virtually interacting with the image of fine art. The plurality of inputs typically include a progression of points or dots which are used by the process to generate and graphically overlay a trace upon the image of fine art. The generated trace reflecting a visual course of observation of the user as the user virtually interacts with the image of fine art.

### CROSS-REFERENCE AND PRIORITY CLAIM TO RELATED APPLICATIONS

Not applicable.

### COPYRIGHT NOTICE

A portion of this disclosure of this patent document contains material which is subject to copyright protection. The owner has no objection to the facsimile reproduction by anyone of the patent disclosure, as it appears in the Patent and Trademark Office patent files or records, but otherwise reserves all copyright rights whatsoever.

### RELEVANT FIELD

The present disclosure generally relates to a computer implemented process and more specifically to a computer-implemented process for virtual interactive appreciation of fine art.

### BACKGROUND

Appreciation of fine art requires a base level of understanding in order to fully appreciate the aesthetic nature, inspiration and/or experience the artist intends to convey to a viewing audience. In a museum or gallery setting, exhibited fine art is one-directional in which artwork is displayed and viewers passively observe the displayed artwork. A strict “look but don't touch” requirement is necessary to prevent the displayed artwork from being degraded or destroyed. However, for many works of art, simple passive viewing of the artwork fails to convey the intended artistic impression to the viewers. This is particularly true for abstract and/or visually complex works of art where the artistic impression of the artist may not readily be apparent or appreciated. While appreciation of a particular piece of artwork is truly a unique personal experience, an uniformed viewer may unwittingly overlook important aspects of the artwork simply by failing to view the artwork from a different perspective. Accordingly, there is a need in the relevant art to provide a mechanism which offers a non-destructive way of allowing viewers to interact with the artwork in order to convey a deeper appreciation of the viewed artwork.

### BRIEF DESCRIPTION OF THE DRAWINGS

The features and advantages of the various exemplary embodiments disclosed herein will become apparent from the following detailed description when considered in conjunction with the accompanying drawings. Where possible, the same reference numerals and characters are used to denote like features, elements, components or portions of various exemplary embodiments. It is intended that changes and modifications can be made to the described exemplary embodiments without departing from the true scope and spirit of the inventive embodiments as defined by the claims.

FIG. 1—depicts a user interface in accordance with an exemplary embodiment.

FIG. 2—depicts a process flow chart for a computer implemented process for interactive fine art appreciation in accordance with an exemplary embodiment.

FIG. 2A—depicts a sub-process flow chart for a computer implemented process for interactive fine art appreciation in accordance with an exemplary embodiment.

FIG. 2B—depicts a sub-process flow chart for a computer implemented process for interactive fine art appreciation in accordance with an exemplary embodiment.

FIG. 2C—depicts another sub-process flow chart for a computer implemented process for interactive fine art appreciation in accordance with an exemplary embodiment.

FIG. 2B—depicts another sub-process flow chart for a computer implemented process for interactive fine art appreciation in accordance with an exemplary embodiment.

FIG. 3—depicts a datastore arrangement for use with a computer implemented process for interactive fine art appreciation in accordance with an exemplary embodiment.

FIG. 4—depicts a block diagram of a computing system for implementing a computer implemented process for interactive fine art appreciation in accordance with an exemplary embodiment.

### SUMMARY

In view of the foregoing, various exemplary embodiments are described herein which address certain of the limitations in the relevant art using a computer implemented process for interactive appreciation of fine art. For purposes of this disclosure, the term “fine art” refers to “a visual work of art considered to have been created primarily for aesthetic purposes and judged for its beauty and meaningfulness, specifically, painting, sculpture, drawing, watercolor, graphics, and architecture,” as defined in www.dictionary.com.

The computer implemented process may be embodied on a tangible and non-transitory computer readable medium. The tangible and non-transitory computer readable medium comprises instructions which when executed by a physical processor(s) causes the physical processor(s) to perform various processing functions including retrieving an image(s) of fine art from a datastore, outputting the retrieved art image to a display, receiving a plurality of user inputs from a user(s) who view and virtually interacts with the art image, interprets the user inputs to generate a trace of the user interactions, displays the trace to the user and stores the generated trace for future viewing. The generated trace reflecting a visual course of observation of the user as the user virtually interacts with the image of fine art.

In an exemplary embodiment, a user experiencing an image of fine art may virtually interact with the art image using an input device coupled to the physical processor. The input device allows the user to provide a plurality of inputs while virtually interacting with the image of fine art. The plurality of inputs typically include a progression of points or dots rendered upon the image of fine art.

The physical processor executing the process for interactive appreciation of fine art utilizes the user's inputs to generate a graphical trace which may be rendered as a transparent overlay upon the art image without altering the underlying artistic subject matter. The graphical trace typically represents a course of observation of the user while virtually interacting with the image of fine art using a touchpad or a touch sensitive screen. The trace records the way the user's eye or hand moves over the work of art.

In an exemplary embodiment, a user may request that an example trace be displayed upon the image of fine art. The example trace typically includes an interpretation of the image of fine art generated by inputs received from an artistically informed user. The artistically informed user may be the rendering artist, an art aficionado, an artistically informed user and/or a user who is familiar with the works of a particular artist. The user may then compare his or her trace to the example trace of the artistically informed user for educational, artistic focus and consciousness raising.

In an exemplary embodiment, a user's trace may also be retrievably recorded in a datastore along with those created by other users. In this exemplary embodiment, each user's trace may be sequentially replayed so as to visually depict how each user viewed and interacted with the image of fine art.

In an exemplary embodiment, a user may also include textual comments and/or annotations concerning the artwork. By way of example and not limitation, likes, dislikes, emotional experiences, and/or comments to other users. In this way, each user's experiences (whether good, bad or indifferent) while interacting with the virtual artwork is bound to the artwork. Accordingly, the accumulated experiences of viewers of the artwork may therefore become part of the artwork, at least in a virtual sense which can be viewed and shared.

### DETAILED DESCRIPTION

Various exemplary embodiments of a computer implemented process for interactive appreciation of fine art are described herein. In the following description, for the purposes of explanation, numerous specific details are set forth in order to provide a thorough understanding of the various exemplary inventive features. It will be apparent, however, to a person having ordinary skill in the art that the various exemplary inventive features may be practiced without these specific details.

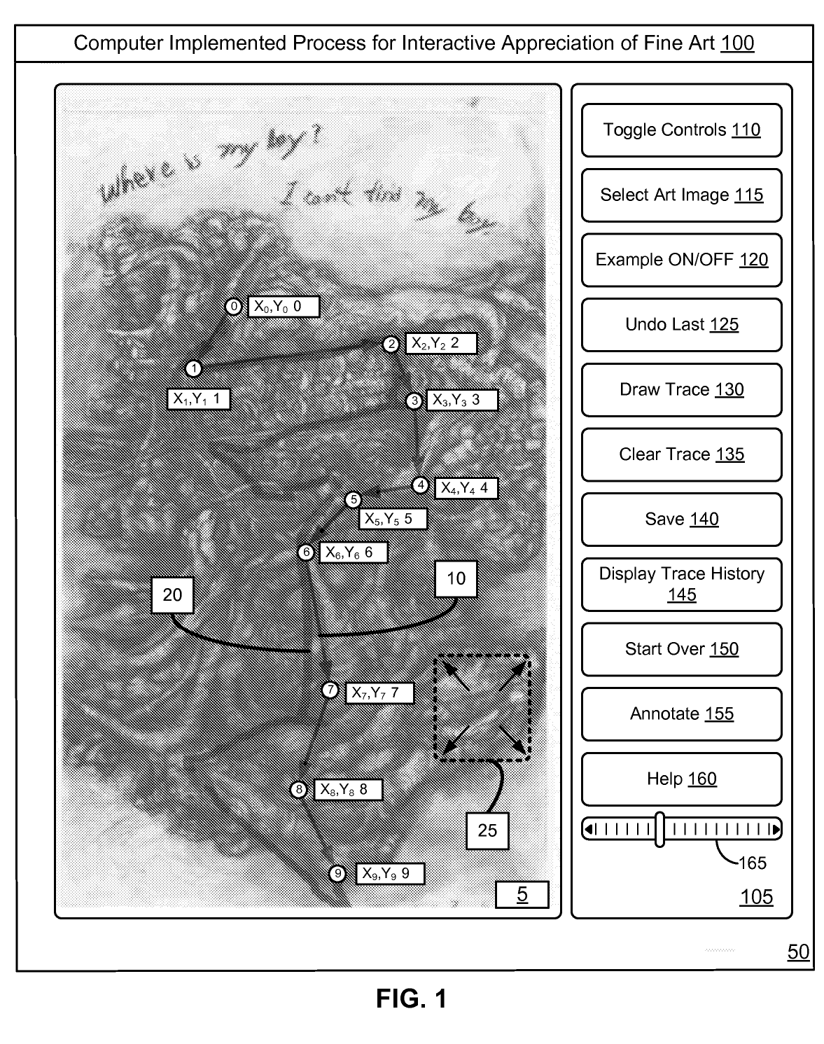

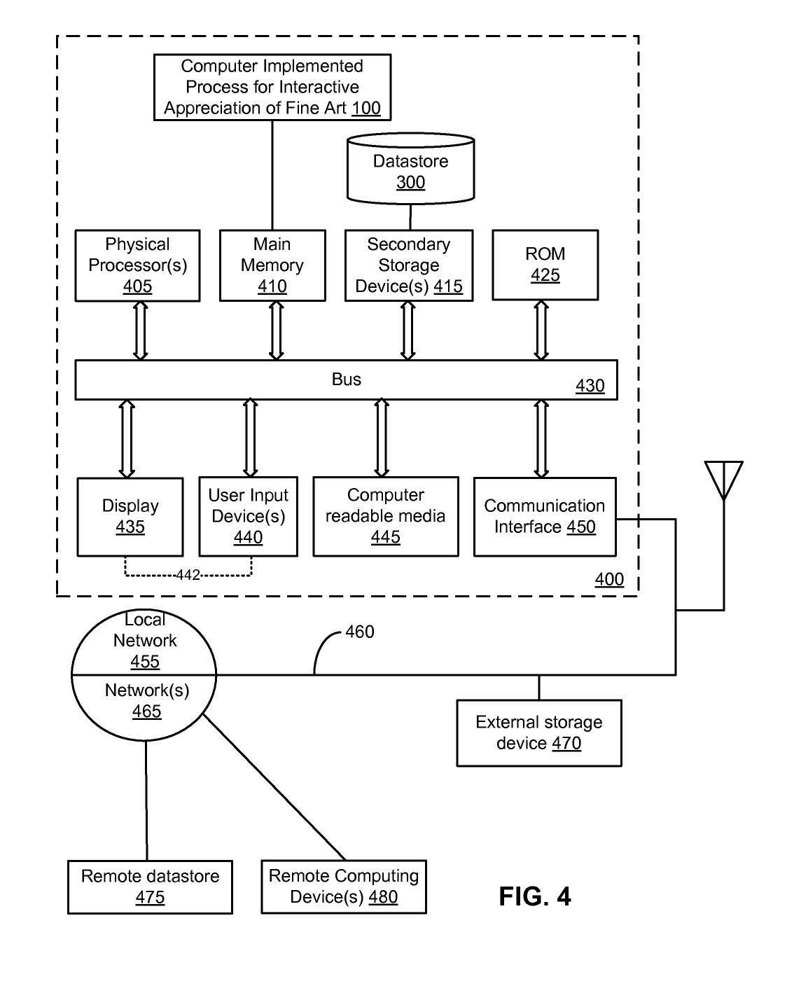

Referring to FIG. 1, an exemplary graphical user interface 50 is depicted which may used to implement the computer implemented process for interactive appreciation of fine art 100. The graphical user interface 50 may be a standalone application or hosted within a web browser. An image of fine art 5 is displayed using the user interface 50. The example image of fine art 5 shown in FIG. 1 is by the renowned centripetal artist Junko Chodos. However, any image of fine art may be used with the computer implemented process for interactive appreciation of fine art 100. In an exemplary embodiment, a user viewing the image of fine art 5 interacts with the art image using a user input device 440 (FIG. 4). In one exemplary embodiment, the user input device 440 (FIG. 5) is preferably incorporated into a display 435 (FIG. 4) as is commonly found in touch screen displays known in the relevant art. Alternately, the user input device 440 may be a separate touchpad or a pointing device such as a mouse trackball, or haptic user interface. The user, while viewing the art image touches (or clicks) on various points 0-9 as he or she observes the displayed artwork 5. Each point 0-9 in which the user touches (or clicks) causes a dot or point to be displayed 0-9. Coordinates (Xᵢ, Yᵢ) for each point 0-9 the user touches (or clicks) is used by the computer implemented process for interactive appreciation of fine art 100 to generate a trace 10 which typically represents a course of observation followed by the user while interacting with the image of fine art 5.

The trace 10 is output to the display 435 generally in a transparent color which contrasts with the underlying image of fine art 5 in order to remain visible. Each point 0-9 may include numbering or lettering which provides the user with an order or sequence in which the points 0-9 were generated. The trace 10 may appear as a continuous line or as a series of line segments which span between each of the points 0-9. The line segments may optionally include arrowheads to illustrate the direction of observation made by the user. In an exemplary embodiment, an area 25 may be selected by the user and rescaled to allow the user a more detailed view of the selected area.

The graphical user interface 50 may include a plurality of controls provided by a control panel 105. For example, a control may be provided which allows the control panel 105 to be toggled (Toggle Controls 110) which hides the control panel 105 from view to allow greater room for viewing an image of fine art 5. Another control may be provided which allows a user to select and display a particular image of fine art (Select Art Image 115). Another control may be provided which displays an example trace 20 (Example ON/OFF 120) generated from inputs received from an artistically informed user. For example, the artist who created the displayed artwork may generate a trace 20 which is intended to emphasize important aspects of the artwork which assists the user in gaining an appreciation of the fine art.

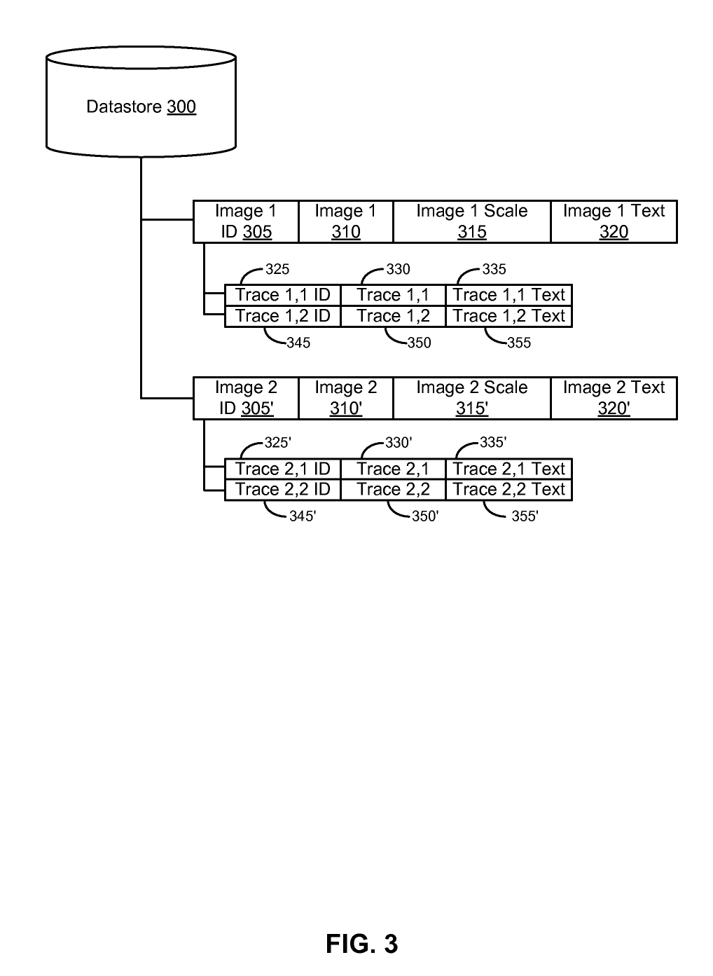

Another control may be provided which allows the user to remove an erroneous point or reverse a previous action (Undo Last 125). Another control may be provided which when selected causes the computer implemented process for interactive appreciation of fine art 100 to generate and render the user's trace 10 (Draw Trace 130). A separate control may be provided to remove the trace 10 generated by the user (Clear Trace 135). This control typically is applicable in situations where the user does not want to add his or her trace to a history of traces stored in a datastore 300 (FIG. 3) or where the user changes his or her mind and decides to perform a different trace. Alternately, another control may be provided which allows the user to add his or her trace to the history of traces stored in the datastore 300 (Save 140). The history of traces stored in the datastore 300 may replayed sequentially using another control (Display Trace History 145) which when selected causes the computer implemented process for interactive appreciation of fine art 100 to sequentially retrieve and display historical traces. This feature allows the user to observe how others may have interacted with the image of fine art 5.

Another control may be provided which allows the user to clear all of the points 0-9 added to the artwork image 5 and start over (Start Over 150). This control is useful in situations where the user has viewed the example trace 20 and desires to experience a different viewpoint of the artwork image 5.

Another control may be provided which allows the user to include annotations along with his or her trace 10 (Annotate 155). Annotations and/or textual comments concerning the artwork, for example likes, dislikes, emotional experiences, and/or perceptional comments may be stored in the datastore 320 along with the user's trace 10. The annotations are made available during replay of historical traces. In this way, each user's experiences (whether good, bad or indifferent) while interacting with the virtual artwork 5 becomes bound with and thus a part of the artwork 5. Another control may be provided which allows the user seeking assistance in generating his or her trace. Alternately, or in addition thereto, information concerning the displayed artwork may be obtained using this control (Help 160).

Another control may be provided which allows the user to adjust the transparency of the example trace 20 so as to better differentiate the user's trace 10 from the example trace 20. In this exemplary embodiment, the transparency control 165 is shown as slide bar. One skilled in the art will appreciate that any number of controls 105 may added or removed as is known in the relevant art concerning graphical user interfaces 50.

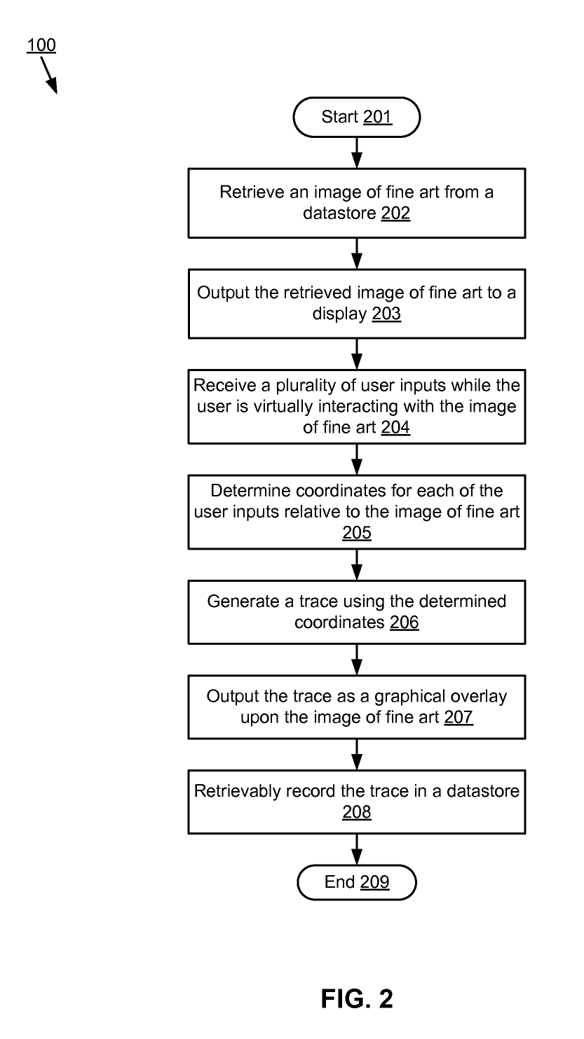

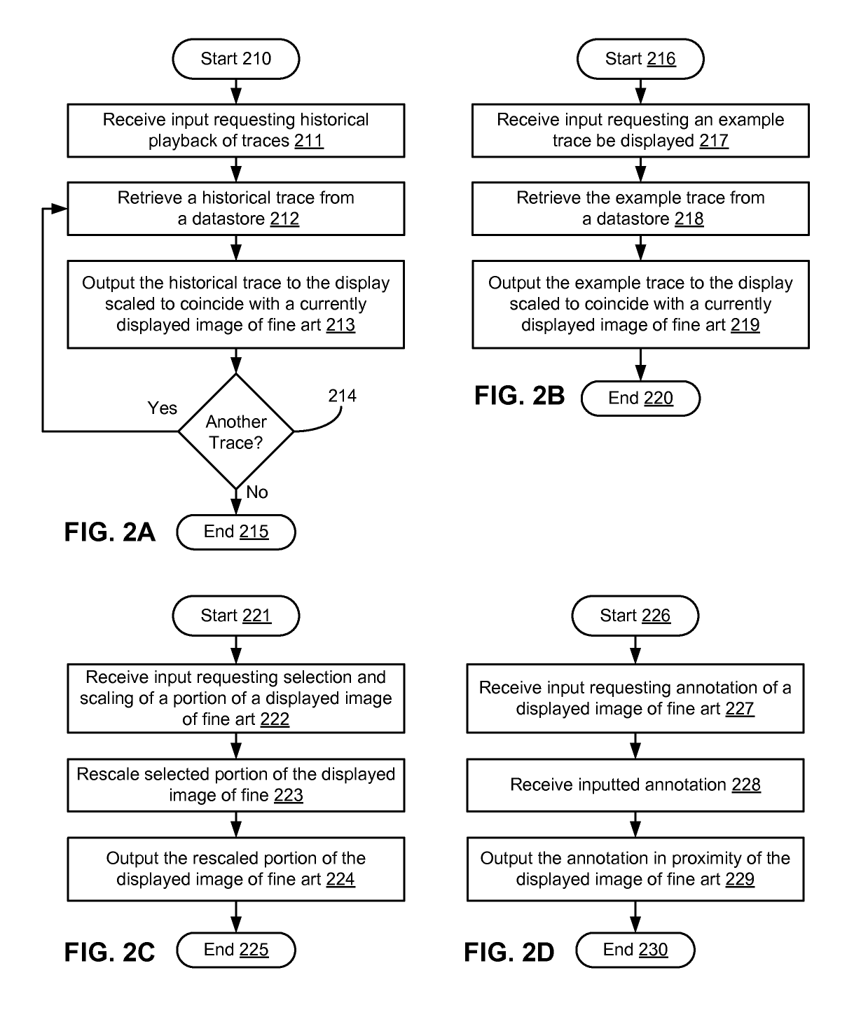

FIG. 2 depicts an exemplary process flow chart for a computer implemented process for interactive fine art appreciation 100. In this exemplary embodiment, the computer implemented process for interactive fine art appreciation 100 is initiated 201 by the retrieval of an image of fine art from a datastore 202. The retrieved image of fine art is then outputted to a display 203. A user, while viewing of the retrieved image of fine art interacts with the displayed artwork image using an input device. A plurality of inputs are received by the computer implemented process for interactive fine art appreciation 100 concurrent with the user's viewing of the artwork 204. The computer implemented process for interactive fine art appreciation 100 determines coordinates from the user inputs which relate to a position on the displayed artwork 205.

Once coordinates have been determined from the user inputs, the computer implemented process for interactive fine art appreciation 100 generates a trace 206 which then output to the display as graphical overlay upon the image of fine art 207. The trace may be generated using simple vector addition, polynomial fit or other algorithms known in the relevant art for rendering of lines. The generated trace may then be recorded in a datastore 208 as a graphic image, coordinators or as vectors. In one exemplary embodiment, processing ends 209 following recordation of the generated trace. Alternately, one or more of the subprocesses described with respect to FIGS. 2A-2D may be executed by the computer implemented process for interactive fine art appreciation 100 when requested by a user.

Referring to FIG. 2A, an exemplary sub-process flow chart for the computer implemented process for interactive fine art appreciation 100 is depicted. In this exemplary embodiment, the computer implemented process for interactive fine art appreciation 100 is initiated 210 when a user requests a historical playback of traces 211. The computer implemented process for interactive fine art appreciation 100 retrieves a historical trace from a datastore 212 and outputs the historical trace to the display scaled to coincide with the currently displayed image of fine art 213. If additional non-displayed historical traces exist in the datastore, the computer implemented process for interactive fine art appreciation 100 sequentially repeats the actions described above until all historical traces contained in the datastore have been displayed 214. Alternately, if all historical traces contained in the datastore have been displayed 214, processing by this sub-process ends 215. Alternately, the user may repeat this sub-process or request that one or more of the subprocesses described with respect to FIGS. 2B-2D may be executed by the computer implemented process for interactive fine art appreciation 100 when requested by a user.

In FIG. 2B, an exemplary sub-process flow chart for a computer implemented process for interactive fine art appreciation 100 is depicted. In this exemplary embodiment, the computer implemented process for interactive fine art appreciation 100 is initiated 216 when a user requests that an example trace be displayed 217. The computer implemented process for interactive fine art appreciation 100 retrieves the example trace from the datastore 218 and outputs the example trace to the display scaled to coincide with a currently displayed image of fine art 219. At this point, processing by this sub-process ends 220. Alternately, the user may repeat this sub-process or request that one or more of the subprocesses described with respect to FIGS. 2A, 2C-2D may be executed by the computer implemented process for interactive fine art appreciation 100 when requested by the user.

In FIG. 2C, another exemplary sub-process flow chart for a computer implemented process for interactive fine art appreciation 100 is depicted. In this exemplary embodiment, the computer implemented process for interactive fine art appreciation 100 is initiated 221 when a user requests selection and scaling of a portion of the displayed image of fine art 222. The computer implemented process for interactive fine art appreciation 100 rescales the selected portion of the displayed image of fine 223 and outputs the rescaled selection to the display 224. At this point processing by this sub-process ends 225. Alternately, the user may repeat this sub-process or request that one or more of the subprocesses described with respect to FIGS. 2A,2B, 2D may be executed by the computer implemented process for interactive fine art appreciation 100 when requested by the user.

In FIG. 2D, another exemplary sub-process flow chart for a computer implemented process for interactive fine art appreciation 100 is depicted. In this exemplary embodiment, the computer implemented process for interactive fine art appreciation 100 is initiated 226 when a user requests annotation of a displayed image of fine art 227. The computer implemented process for interactive fine art appreciation 100 receives annotations input by the user 228 either through the graphical user interface 50 (FIG. 1) or a keyboard input device and outputs the annotation in proximity of the displayed image of fine art 229. At this point processing by this sub-process ends 230. Alternately, the user may repeat this sub-process or request that one or more of the subprocesses described with respect to FIGS. 2A-2C may be executed by the computer implemented process for interactive fine art appreciation 100 when requested by the user.

Referring to FIG. 3, an exemplary datastore 300 for use with a computer implemented process for interactive fine art appreciation 100 is depicted. In this exemplary embodiment, the datastore 300 is configured as a database. The datastore 300 includes or refers to a plurality of uniquely identified fine art images records 305, 305′. Each image record 305, 305′ includes or refers to an image file 310, 310′. The fine art image files 310, 310′ are typically high resolution (≧300 dpi) *.tiff or *.jpg formatted graphic files which may be scaled to fit large format video displays without significant loss of resolution. One skilled in the art will appreciate that other graphic file formats may be used as well.

The fine art image records 305, 305′ may have associated therewith an image scale 315, 315′ for proper rendering of the fine art images 310, 310′ to a display. In addition, the fine art image records 305, 305′ may have associated therewith descriptive text 320, 320′ which provides information about the fine art images 310, 310′ in which the descriptive text 320, 320′ is associated with. For example, the descriptive text may include or refer to a discussion of the artwork provided by the artist or another knowledgeable party.

The fine art image records 305, 305′ may also have associated therewith, a plurality of uniquely identified trace records 325, 345, 325′, 345′ recorded and stored in the datastore 300 by various users who have virtually interacted with the images of fine art 310, 310′. Each trace record 325, 345, 325′, 345′ includes or refers to a trace 330, 350, 330′, 350′ recorded by a user. The actual traces 330, 350, 330′, 350′ are typically recorded as graphic images in any convenient format and in medium resolution of at least 72 dpi to reduce storage requirements and processing overhead during rendering. The trace records 325, 345, 325′, 345′ may further have associated therewith text records 335, 355, 335′, 355′ containing annotations and/or comments made by a user during generation of the trace records 325, 345, 325′, 345′. The user input points shown in FIG. 1 may be recorded in a lookup table as coordinates as is shown in Table 1 below. The coordinates may be in any convenient type including Cartesian or Polar coordinate systems. In an exemplary embodiment, a third dimension may be included to provide textural feedback to a user utilizing a haptic feedback input device.

TABLE 1

| | | | | |
|---|---|---|---|---|
| Image ID 305 | 1 | | | |
| | Trace ID 325 | 1, 1 | | |
| | | | Point | Coordinates |
| | | | 0 | X₀, Y₀ |
| | | | 1 | X₁, Y₁ |
| | | | 2 | X₂, Y₂ |
| | | | 3 | X₃, Y₃ |
| | | | 4 | X₄, Y₄ |
| | | | 5 | X₅, Y₅ |
| | | | 6 | X₆, Y₆ |
| | | | 7 | X₇, Y₇ |
| | | | 8 | X₈, Y₈ |
| | | | 9 | X₉, Y₉ |

Alternately, traces and annotations provided by a user may be incorporated with or referentially accompanying the traces 330, 350, 330′, 350′ as graphic images. One skilled in the art will appreciate that other data storage structural arrangements may be implemented as well.

### IMPLEMENTATION MECHANISMS

### Hardware Overview

FIG. 4 depicts an exemplary block diagram of a computing system arrangement upon which inventive embodiments of the computer-implemented process for interactive appreciation of fine art 100 may be implemented. In an exemplary embodiment, the computing system 400 is implemented as a type of a Turing machine which transforms indicia of user inputs into a trace overlaid upon an image of fine art output to a display 435. In an exemplary embodiment, the Turing machine is a web enabled computer specifically programmed to execute the computer-implemented process for interactive appreciation of fine art 100 (FIGS. 2, 2A-2D.)

The computing system 400 includes a bus 430 or other communications infrastructure for communicating information, one or more physical processors 405 coupled with the bus 430 for processing information. The one or more physical processors 405 may be those manufactured for example by Intel, AMD, Motorola, Texas Instruments or other electronic component manufacturer. The computing system 400 further includes a main memory 410, such as a random access memory (RAM) and a other secondary storage device 415 coupled to the bus 430 for storing information and instructions to be executed by the physical processor(s) 405. For example, the computer-implemented process for interactive appreciation of fine art 100. The main memory 410 may also be used for storing temporary variables or other intermediate information during execution of instructions to be executed by the physical processor(s) 405. The computing system 400 further includes a read only memory (ROM) 425 or other nonvolatile data storage device coupled to the bus 430 for storing static information and instructions for the physical processor(s) 405. Secondary storage device(s) 415, such as a magnetic disk and/or optical disk, is provided and coupled to the bus 430 for storing information and instructions. For example, a datastore 300 may be stored in on the Secondary storage device(s) 415 which is made accessible and retrievable by the physical processor(s) 405 via the bus 430.

The computing system 400 may be coupled via the bus 430 to a display 435, such as a cathode ray tube (CRT), plasma display or light emitting diode display (LED), for displaying information to a computer user. One or more user interface devices 440, including a keyboard and/or touch screen is coupled to the bus 430 for communicating information and command selections to the physical processor(s) 405. In a preferred exemplary embodiment, the user input device 440 is a touch screen coupled 442 with the display 435 for receiving tactile user inputs. In an exemplary embodiment, other types of user input devices 440 provides cursor control, such as a mouse, a trackball, cursor direction keys, or haptic feedback device for communicating direction information and command selections to the physical processor(s) 405 and for controlling cursor movement on the display 435.

The various inventive embodiments described above are related to the use of the computing system 400 for implementing the processes described herein. According to one inventive embodiment, those processes are performed by the computing system 400 in response to the physical processor(s) 405 executing one or more sequences of one or more instructions contained in the main memory 410. Such instructions may be read into the main memory 410 from the secondary storage device(s) 415, or an external storage device(s) 470, 475 coupled to one or more network(s) 455, 465. Execution of the sequences of instructions contained in the main memory 410 causes the physical processor(s) 405 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer readable media” 445 as used herein refers to any tangible and non-transitory media that participates in providing data that causes the computing system 400 to operate in a specific fashion. In an exemplary embodiment implemented using the computing system 400, various computer readable media 445 may be involved, for example, in providing instructions to the physical processor(s) 405 for execution. Such a medium may take many forms, for example, optical or magnetic disks, such as the secondary storage device(s) 415. Volatile non-transient media includes dynamic memory, such as the main memory 410.

Common forms of tangible non-transient computer readable media 415 include, for example, a floppy disk, a flexible disk, hard disk, magnetic tape, or any other magnetic medium, a CD-ROM, DVD or any other optical medium, punch cards, paper tape, any other physical medium with patterns of holes, a RAM, a PROM, and EPROM, a FLASH-EPROM, EEPROM, FLASH-RAM and/or any other memory chip or cartridge as described hereinafter, or any other medium from which the physical processor(s) 405 of the computing system 400 can read.

Various forms of computer readable media may be involved in carrying one or more sequences of instructions to the physical processor(s) 405 for execution. For example, the instructions may initially be carried on a magnetic disk of a remote computing device(s) 480. A remote computing device(s) 480 can load the instructions into its dynamic memory and send the instructions over the network(s) 465, 455. A communication interface 450 is coupled to the bus 430 of the computing system 400 and can receive and convert the data to a form which can be transferred to the bus 430. The bus 430 carries the data to main memory 410, from which the physical processor(s) 405 retrieves and executes the instructions. The instructions received by the main memory 410 may optionally be stored on the secondary storage devices(s) 415 or external storage device 470, 475 either before or after execution by the physical processor(s) 405.

The communication interface 450 provides a two-way data communication coupling to a network link 460 that is connected to the one or more networks 455, 465. For example, the communication interface 450 may be an integrated services digital network (ISDN) card or a digital subscriber line (DSL) modem to provide a data communication connection to a corresponding type of telephone line. In another example, the communication interface 450 may be a local area network (LAN) card to provide a data communication connection to a compatible LAN.

Wireless links may also be implemented. In any such implementation, the communication interface 450 sends and receives electrical, electromagnetic and/or optical signals that carry digital data streams representing various types of digital information. The communications link 460 typically provides data communication through one or more networks 455, 460 to other data devices. For example, the communications link 460 may provide a connection through the networks 455, 465 to one or more remote computing device(s) 480. The communications link 460 and the network(s) 455, 465 may use electrical, electromagnetic and/or optical signals that convey digital data streams. The computing system 400 can send messages and receive data, including program code, through the networks 455, 465, the communications link 460 and the communication interface 450. The received code may be executed by the physical processor(s) 405 as it is received, and/or stored in the secondary storage device(s) 415 or on computer readable media 445, or other non-volatile storage for later execution.

Where necessary, computer programs, applications, algorithms, scripts and routines are envisioned to be programmed in a high level language object oriented language, by way of example an not limitation, Apache Cocoon, Java, C, C++, C#, CORBA, Visual Basic, JavaScript, Perl, Flash, and/or Python. Database components may utilize any common database program, by way of example and not limitation, ORACLE, Sequel Server, MySQL, SQL, MS ACCESS, DB2, MS FOXBASE, DBASE, PostgreSQL and RBASE.

For purposes of this disclosure, the term “program” is intended to be interpreted in its broadest sense to include all instructions executable by the physical processor(s) 405 whether embodied in hardware or software. Where applicable, references to various programs may be made in both singular and plural form. No limitation is intended by such grammatical usage as one skilled in the art will appreciate that multiple programs, applications, processes, objects, scripts, subprograms, subroutines, algorithms, applets, contexts, order of process execution, etc. may be implemented programmatically to implement the various inventive embodiments.

### Extensions and Alternatives

In the foregoing specification, the various exemplary inventive features have been described with reference to specific embodiments herein. It will, however, be appreciated by a person having ordinary skill in the art that various modifications and changes may be made thereto without departing from the broader spirit and scope of the various inventive embodiments disclosed. The specification and drawings are, accordingly, to be regarded in an exemplary rather than in a restrictive sense.

1. A computer implemented process for virtual interactive appreciation of a work of fine art without actual physical contact therewith, the computer implemented process comprising:
outputting an image of the fine art to a display;
receiving a plurality of inputs from a user virtually interacting with the image of fine art via an input device;
generating a trace from the plurality of inputs;
outputting the trace of the user inputs as a graphical overlay rendered upon the image of fine art, the trace representing a course of visual observation followed by the user when virtually interacting with the image of fine art;
outputting a predefined example trace to the display in such a way that the user can interactively compare his or her trace with that of the example trace, the predefined example trace including an artistic interpretation of the image of fine art generated by an artistically informed user;
wherein the trace is rendered upon the image of fine art without altering underlying artistic subject matter contained in the image of fine art.

2. The computer implemented process of claim 1 further comprising recording the trace as a digitized visual record of a course of observation followed by the user while interacting with the image of fine art, such that the digitized visual record becomes a virtual part of the image of fine art.

3. The computer implemented process of claim 1 wherein the plurality of inputs are a progression of points rendered upon the image of fine art.

4. The computer implemented process of claim 3 wherein the trace includes one or more line segments connecting the progression of points.

5. The computer implemented process of claim 1 wherein the outputted trace is a course of observation followed by the user while interacting with the image of fine art for any of education, artistic focus and consciousness raising.

6. The computer implemented process of claim 1 wherein the plurality of inputs includes user annotations.

7. The computer implemented process of claim 1 wherein the trace is outputted to the display in a color which contrasts with the image of fine art.

8. The computer implemented process of claim 1 wherein the input device is a touchpad.

9. The computer implemented process of claim 1 wherein at least of a portion of the image of fine art is separately selectable or scalable.

10. The computer implemented process of claim 1 wherein the outputted image of fine art is one of a plurality of images of fine art retrievably stored in a datastore.

11. A computer implemented process for virtual interactive appreciation of a work of fine art without actual physical contact therewith, the computer implemented process comprising:
outputting an image of the fine art to a touch screen display;
receiving a plurality of tactile inputs from a user virtually interacting with the image of fine art from the touch screen display;
determining coordinates for each of the plurality of tactile inputs relative to the image of fine art;
generating a trace using the determined coordinates;
outputting the trace rendered as a graphical overlay upon the image of fine art to the touch screen display;
outputting a predefined example trace to the display in such a way that the user can interactively compare his or her trace with that of the example trace, the predefined example trace including an artistic interpretation of the image of fine art generated by an artistically informed user;
retrievably recording the trace in a datastore;
wherein the trace representing a course of visual observation followed by the user when virtually interacting with the image of fine art.

12. The computer implemented process of claim 11 further comprising:
retrieving at least one trace from the datastore;
outputting the retrieved trace as a graphical overlay rendered upon the image of fine art.

13. The computer implemented process of claim 11 wherein the datastore includes a plurality of traces recorded from different users.

14. The computer implemented process of claim 13 further comprising sequentially outputting the plurality of traces retrieved from the datastore as graphical overlays rendered upon the image of fine art when requested by a user.

15. A computer implemented process for virtual interactive appreciation of a work of fine art without actual physical contact therewith, the computer implemented process comprising:
retrieving an image of the fine art from a datastore;
outputting the image of the fine art to a display;
receiving a plurality of tactile user inputs generated while a user is virtually interacting with the image of fine art;
generating a trace from the plurality of tactile inputs, the trace representing a course of observation followed by the user while interacting with the image of fine art;
outputting the trace rendered upon the image of fine art to the touch screen display without altering the image of fine art;
outputting a predefined example trace to the display in such a way that the user can interactively compare his or her trace with that of the example trace, the predefined example trace including an artistic interpretation of the image of fine art generated by an artistically informed user;
wherein the trace representing a course of visual observation followed by the user when virtually interacting with the image of fine art.

16. (canceled)

17. The computer implemented process of claim 15 wherein the trace is rendered upon the image of fine art as a colored and discernable transparency line.

18. The computer implemented process of claim 17 wherein the colored and discernable transparency line is rendered in a color which contrasts with the image of fine art.

19. A computer program product comprising instructions embodied on a tangible and non-transitory computer readable medium executable by a physical processor to execute the computer implemented process for interactive appreciation of fine art of claim 1.

20. A computing system comprising:
a physical processor;
a touch screen display coupled to the physical processor;
a memory coupled to the processor, the memory comprising instructions which when executed by the physical processor, causes the physical processor to execute the computer implemented process for interactive appreciation of fine art of claim 1.
